(19) United States
(12) Patent Application Publication
(10) Pub. No.: US 2012/0009463 A1
(43) Pub. Date: Jan. 12, 2012

(54) CASE FOR SECONDARY BATTERY AND SECONDARY BATTERY INCLUDING THE SAME

(76) Inventor: Sang-Joon LEE, Yongin-si (KR)

(21) Appl. No.: 13/180,770

(22) Filed: Jul. 12, 2011

(30) Foreign Application Priority Data
Jul. 12, 2010 (KR) 10-2010-0066860

(51) Int. Cl. H01M 2/10; H01M 10/00; H01M 2/02

(52) U.S. Cl. 429/163

(57) ABSTRACT

A case for a secondary battery and a secondary battery including the same, the case including a case body, the case body having bottom and a space for receiving an electrode assembly; and a shock-absorbing cap, the shock-absorbing cap having a bottom and an edge extending from the bottom of the shock-absorbing cap, the edge being coupled to the bottom of the case body, wherein the shock-absorbing cap includes a sub-shock absorber, the sub-shock absorber being configured to distribute and transmit shock applied to the bottom of the shock-absorbing cap.

### BACKGROUND

1. Field

Embodiment relate to a case for a secondary battery and a secondary battery including the same.

2. Description of the Related Art

As a variety of mobile devices have been widely used in recent years, many studies about secondary batteries used as power suppliers have been conducted.

Secondary batteries may include, e.g., a nickel-cadmium battery, a nickel-hydrogen battery, a nickel-zinc battery, and a lithium battery. Secondary batteries may have a basic structure in which a jelly-roll shape electrode assembly with a separator between an anode and a cathode is sealed in a rectangular or a cylindrical case.

Cases for the secondary batteries may include a cap assembly having an electrode terminal on the top of a case body accommodating the electrode assembly.

### SUMMARY

Embodiments are directed to a case for a secondary battery and a secondary battery including the same.

At least one of the above and other features and advantages may be realized by providing a case for a secondary battery, the case including a case body, the case body having bottom and a space for receiving an electrode assembly; and a shock-absorbing cap, the shock-absorbing cap having a bottom and an edge extending from the bottom of the shock-absorbing cap, the edge being coupled to the bottom of the case body, wherein the shock-absorbing cap includes a sub-shock absorber, the sub-shock absorber being configured to distribute and transmit shock applied to the bottom of the shock-absorbing cap.

The sub-shock absorber may include one or more shock-absorbing grooves on the shock-absorbing cap, the shock-absorbing grooves having a predetermined depth.

The sub-shock absorber may include a plurality of the shock-absorbing grooves at regular intervals.

Each of the plurality of shock-absorbing grooves may have the same area.

The sub-shock absorber may include a plurality of the shock-absorbing grooves, the shock-absorbing grooves being symmetrically disposed at sides of a center of the shock-absorbing cap.

The sub-shock absorber may include a plurality of the shock-absorbing grooves, the shock-absorbing grooves being disposed at opposite side ends of the shock-absorbing cap.

The shock-absorbing cap may further include connection ribs between the shock-absorbing grooves, and the connection ribs and the edges of shock-absorbing cap may contact the bottom of the case body.

The shock-absorbing cap may be made of polycarbonate.

The case for a secondary battery may further include shock-absorbing blocks in the shock-absorbing grooves.

The shock-absorbing blocks may include an elastic body, the elastic body having an elasticity greater than an elasticity of the shock-absorbing case.

The elastic body may include any one of rubber and an adhesive.

The shock-absorbing cap may have a thickness, and the predetermined depth may be about 50% or less of the thickness of the shock-absorbing cap.

The predetermined depth may be about 0.1 mm to about 0.25 mm.

The shock-absorbing cap may further include one or more connecting protrusions on the edge of the shock-absorbing cap, the connecting protrusions extending along and covering a side of the bottom of the case body.

The connection protrusions may be on a long side of the edge of the shock-absorbing cap.

At least one of the above and other features and advantages may also be realized by providing a case for a secondary battery, the case including a case body, the case body having a bottom and a space for receiving and electrode assembly; a shock-absorbing cap, the shock-absorbing cap including a bottom, an edge extending from a side of the bottom of the shock-absorbing cap, the edge being coupled to the bottom of the case body, one or more connecting protrusions extending from long sides of the edge; and a specific shock-absorbing block on top of the shock-absorbing cap.

The shock-absorbing cap may be made of any one of polycarbonate and polypropylene.

The shock-absorbing block may be stacked on top of the shock-absorbing cap.

The shock-absorbing block may be made of a material having an elasticity greater than an elasticity of the shock-absorbing cap.

The shock-absorbing block may include any one of rubber and an adhesive.

At least one of the above and other features and advantages may also be realized by providing a secondary battery including a case for a secondary battery according to an embodiment; an electrode assembly in the case; and a cap assembly connected with the electrode assembly and coupled to an upper end of a case body.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a case according to an embodiment;

FIG. 2 illustrates a cross-sectional view of an assembled state of the case of FIG. 1;

FIG. 3A illustrates a plan view of a shock-absorbing cap of the case of FIG. 1;

FIG. 3B illustrates a plan view of a modified example of the shock-absorbing cap of FIG. 1;

FIG. 3C illustrates a plan view of another modified example of the shock-absorbing cap of FIG. 1;

FIG. 3D illustrates a plan view of yet another modified example of the shock-absorbing cap of FIG. 1;

FIG. 4 illustrates an exploded perspective view of a case according to another embodiment;

FIG. 5 illustrates a cross-sectional view of an assembled state of the case of FIG. 4;

FIG. 6 illustrates an exploded perspective view of a case according to yet another embodiment;

FIG. 7 illustrates a cross-sectional view of an assembled state of the case of FIG. 6;

FIG. 8 illustrates a cross-sectional view of a case according to still another embodiment;

FIG. 9A illustrates an enlarged cross-sectional view of a modified example of a shock-absorbing cap of FIG. 8; and

FIG. 9B illustrates an enlarged cross-sectional view of another modified example of a shock-absorbing cap of FIG. 8.

### DETAILED DESCRIPTION

Korean Patent Application No. 10-2010-0066860, filed on Jul. 12, 2010, in the Korean Intellectual Property Office, and entitled: “Case of Secondary Battery and Secondary Battery Thereof” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout

When it is determined that detailed descriptions for well-known technologies or configurations may unnecessarily make the point of the present invention unclear, the detailed descriptions are not provided, in explaining the present invention. Further, it should be noted that the same components shown in the drawings are designated by the same reference numerals and characters, even if they are shown in different drawings. Furthermore, the size or the thickness of each layer may be exaggerated in the drawings for the convenience of description and clarity, and may be different from the actual thickness or size of the layers.

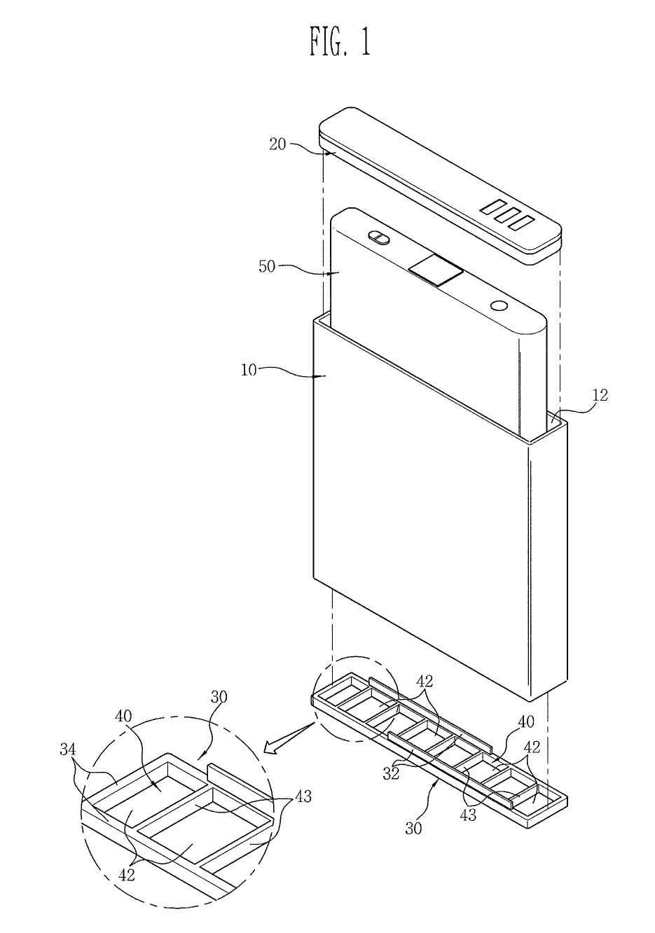

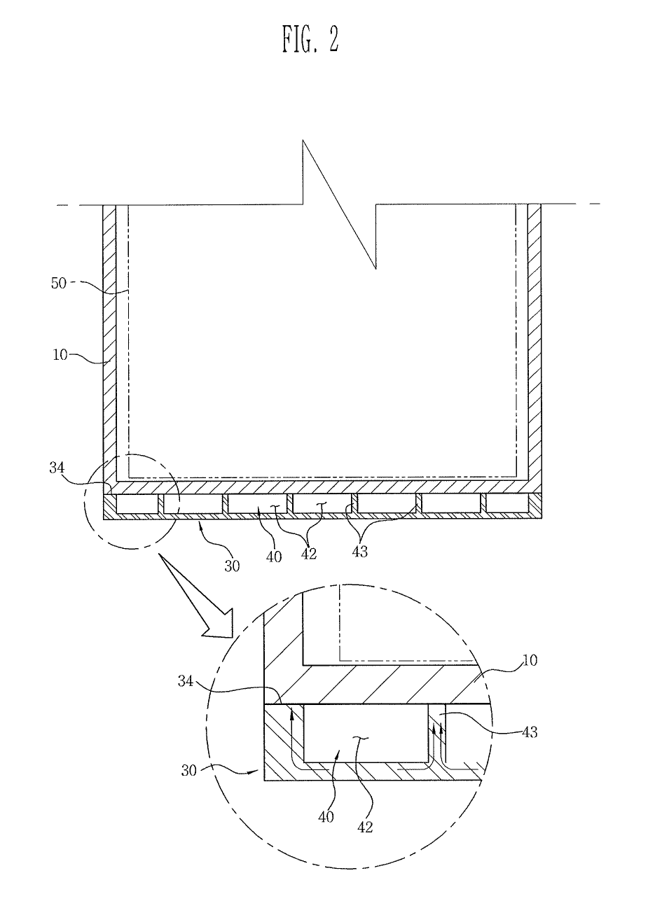

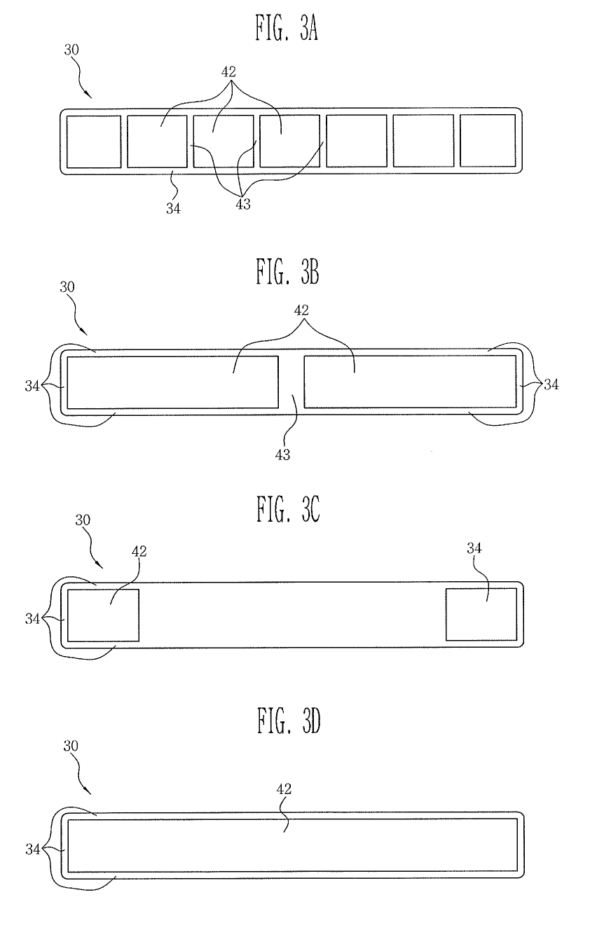

FIG. 1 illustrates an exploded perspective view of a case according to an embodiment. FIG. 2 illustrates a cross-sectional view of an assembled state of the case of FIG. 1. FIGS. 3A to 3D illustrate plan views of modified examples of a shock-absorbing cap of FIG. 1.

As shown in FIGS. 1 and 2, a case for a secondary battery may include a case body 10, a case assembly 20, and a shock-absorbing cap 30 including a sub-shock absorber 40.

The case body 10 may function as a case and an electrode for an electrode assembly 50, may have a receiving space 12 for receiving the electrode assembly 50 therein, and may have a box shape with a closed bottom and an open top for insertion of the electrode assembly 50.

The case body 10 may have, e.g., a cylindrical or rectangular, shape in accordance with a desired type of battery; and a rectangular shape is exemplified in the present embodiment.

The electrode assembly 50 may be received in the case body 10 and may substantially generate current in the secondary battery. The electrode assembly 50 may be wound in a jelly-roll shape. The jelly-roll shaped electrode assembly 50 may include an anode plate formed by coating an anode active material on an anode current collector, a cathode plate formed by coating a cathode active material on a cathode current collector, and a separator between the anode plate and the cathode plate to electrically connect them.

The electrode assembly 50 may be connected with the case body 10 and an anode terminal of the cap assembly 20 (described below).

The electrode assembly 50 and the cap assembly 20 may have a structure well-known in the art, and they are not described and shown in the drawings in detail.

The shock-absorbing cap 30 may be attached to the bottom of the case body 10 equipped with the electrode 50 and the cap assembly 20. The shock-absorbing cap 30 may be called a bottom case, but is referred to as the shock-absorbing cap 30 to discriminate from the case body 10 of the secondary battery. The shock-absorbing cap 30 may include an edge 34 extending along a periphery of a bottom thereof.

The shock-absorbing cap 30 may function as a protecting member that covers the bottom of the case body 10 where a relatively large shock may be applied, e.g., when the secondary battery falls on the ground etc. The shock-absorbing case 30 may have a simple plate shape having an area substantially the same as an area of the bottom of the case body 10. A top of the shock-absorbing cap 30 may be in close contact with the bottom of the case body 10.

The shock-absorbing cap 30 may be made of a synthetic resin, e.g., PC (polycarbonate) or PP (polypropylene). However, any suitable materials may be selected and used, as long as they exhibit sufficient shock-absorbing properties.

The shock-absorbing cap 30 may include connecting protrusions 32 at front and rear edges thereof. The connecting protrusions 32 may cover a lower outer or side surface of the case body 10 when the shock-absorbing cap 30 is coupled with the case body 10. The connecting protrusions 32 may extend along long sides of the edge 34 coupled with the case body 10.

It is possible to fix the shock-absorbing cap 30 to the case body 10 by attaching a label tape (not shown) thereto, e.g., to an outer surface of the case body 10 and to the connecting protrusions 32 in this position.

The shock-absorbing cap 30 may include the sub-shock absorber 40 in order to increase shock-absorbing efficiency by transferring shock applied to the shock-absorbing cap 30 to an outer edge thereof. The sub-shock absorber 40 may include a groove (hereafter, referred to as ‘shock-absorbing groove 42) on the shock-absorbing cap 30.

For example, the shock-absorbing groove 42 may have a predetermined depth from a top of the shock-absorbing cap 30. A plurality of the shock-absorbing grooves 42 may be arranged at regular intervals along an entire surface of the top of the shock-absorbing cap 30. The depth of the shock-absorbing grooves 42 with respect to a thickness of the shock-absorbing cap 30 may have a greater effect on shock absorption than a number of the shock-absorbing grooves 42. In an implementation, the depth of the shock-absorbing groove 42 may be within about 50% of the thickness of the shock-absorbing cap 30. In other words, the depth of the shock-absorbing groove 42 may be about 50% or less of the thickness of the shock-absorbing cap 30. Maintaining the depth of the groove at about 50% or less of the thickness of the shock-absorbing cap 30 may help ensure that the shock-absorbing cap 30 has sufficient strength. In an implementation, the depth may be about 0.1 mm to about 0.25 mm. Maintaining the depth at about 0.1 mm or greater may help ensure that shock-absorbing properties are not reduced. Maintaining the depth at about 0.25 mm or less may help ensure that the shock-absorbing cap 30 has sufficient strength.

As the plurality of shock-absorbing grooves 42 are formed, ribs 43, which may serve as reinforcing members, may be correspondingly formed between the shock-absorbing grooves 42. As shown in FIG. 2, only an upper portion of the edge 34 and the ribs 43 of the shock-absorbing cap 30 may contact the bottom of the case body 10 when the shock-absorbing cap 30 is coupled with the case body 10.

For example, a contact area between the shock-absorbing cap 30 and the case body 10 may be reduced, as compared with a case in which an entire surface of a shock-absorbing cap is in close contact with a case body. Accordingly, shock load applied to the shock-absorbing cap 30 may be transmitted only through the edge 34 and the ribs 43. For example, arrows shown in the ribs 43 and edges 34 represent a path of the shock applied to the shock-absorbing cap 30 and transmitted to the case body 10.

In addition to the structure shown in FIGS. 1 to 3A, in an implementation, e.g., two shock-absorbing grooves 42 may be disposed to the left and right of a center of the shock-absorbing cap 30, as shown in FIG. 3B. In another implementation, e.g., two shock-absorbing grooves 42 may be disposed at left and right side ends of the shock-absorbing cap 30, as shown in FIG. 3C. For example, a large shock load due to, e.g., falling, may be applied particularly to both side ends. Thus, it may be considerably effective to form the shock-absorbing grooves 42 at both side ends. Further, areas of each of the shock-absorbing grooves 42 may be the same. In an implementation, the shock-absorbing cap 30 may be symmetric with respect to the center, in view of desired shock distribution.

In an implementation, the shock-absorbing cap 30 may include one integral shock-absorbing groove 42, as shown in FIG. 3D. In addition, the structure may be modified in various ways, as long as the contact area between the shock-absorbing cap 30 and the case body 10 is reduced by the shock-absorbing grooves 42.

As described above, the shock-absorbing cap 30 may be made of a synthetic resin, e.g., PC (polycarbonate) or PP (polypropylene). However, polycarbonate may be preferable to polypropylene in terms of strength, for the shock-absorbing grooves 42 in the structure of the present embodiment.

Next, operation and effects achieved in operation of the present embodiment having the above-described configuration will be described.

If a complete product achieved by combining the case body 10 with the shock-absorbing cap 30 having the shock-absorbing grooves 42, as shown in FIG. 2, accidentally falls or external shock is otherwise applied to the bottom of the case body 10, the shock-absorbing cap 30 may primarily absorb the shock, such that the load may be reduced prior to being transmitted to the case body 10.

As described above, the shock-absorbing grooves 42 may be formed on the shock-absorbing cap 30. Thus, the shock load initially applied to the shock-absorbing cap 30 may be naturally dispersed throughout the ribs 43 and the edge 34, except for the shock-absorbing grooves 42.

For example, the load initially applied to the shock-absorbing cap 30 may be transmitted to the case body 10 only through the ribs 43 and the edge 34.

Accordingly, the load transmitted through the ribs 43 may be locally exerted on the bottom of the case body 10; and the load dispersed to the edge 34 of the shock-absorbing cap 30 may be exerted on the edge of the bottom of the case body 10.

As the load applied to the shock-absorbing cap 30 may be locally transmitted to the bottom of the case body 10 through the ribs 43, as described above, the shock applied to the case body 10 may be attenuated ore weakened, as compared with a case in which load is applied to a shock-absorbing cap and an entire bottom of a case body.

Further, since the electrode assembly 50 may not be press-fitted in the case body 10, but rather may include a space between the electrode assembly 50 and an inner side of the case body 10, as shown in FIG. 2, if a load is transferred to the edge 34 of the shock-absorbing cap 30 and transmitted to the edge of the bottom of the case body 10, the load exerted on the edge of the case body 10 may not be directly transmitted to the electrode assembly 50.

For example, the groove-shaped sub-shock absorber 40 may be formed in the shock-absorbing cap 30 in the present embodiment. Thus, load applied to the shock-absorbing cap 30 may be transferred and concentrated to specific portions before being transmitted to the case body 10. As a result, the load applied to the case body 10 and the electrode assembly 50 may be attenuated, thereby protecting a secondary battery including such a structure.

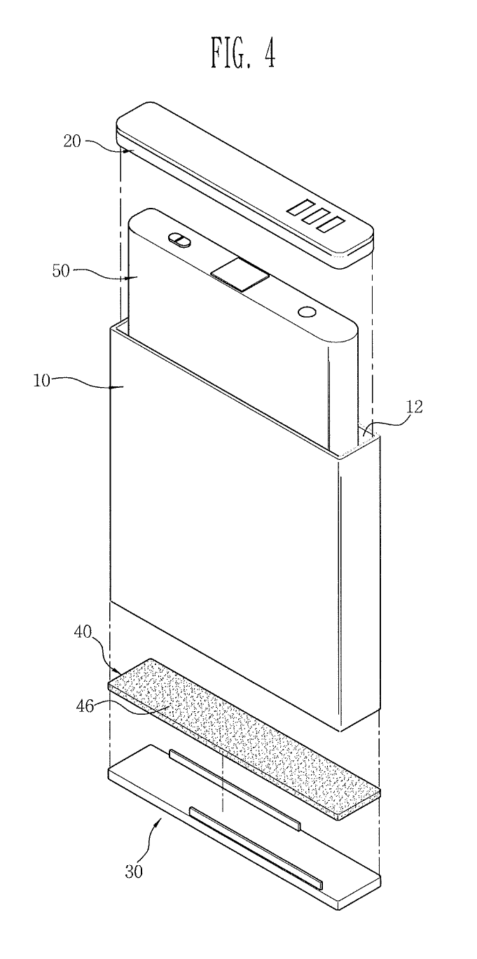

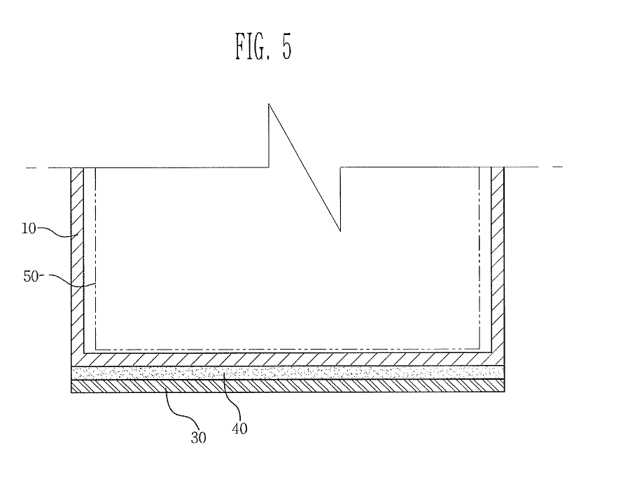

FIG. 4 illustrates an exploded perspective view of a case according to another embodiment. FIG. 5 illustrates a cross-sectional view of an assembled state of the case of FIG. 4. FIGS. 4 and 5 illustrate another embodiment in which a basic design of forming a sub-shock absorber 40 on a shock-absorbing cap 30 is the same as the previous embodiment. However, a difference includes a sub-shock absorber 40 without shock-absorbing grooves 42, but rather a specific plate.

For example, the sub-shock absorber 40 according to the present embodiment may be formed of a simple rectangular plate, as shown in FIG. 4. Accordingly, the shock-absorbing cap 30 may have a flat top.

For example, a shock-absorbing block 46 may be formed of a plate having an area about the same as an area of a top of the shock-absorbing cap 30. In an implementation, the shock-absorbing block 46 may be made of a material that is more elastic than the shock-absorbing cap 30. In an implementation, flexible materials, e.g., rubber, may be used and may have self-shock absorbing ability.

The shock-absorbing block 46 may be stacked on top of the shock-absorbing cap 30 and may be between the top of the shock-absorbing cap 30 and the bottom of the case body 10, when the shock-absorbing cap 30 is combined with the case body 10, as shown in FIG. 5.

In this configuration, the shock-absorbing block 46 and the shock-absorbing cap 30 may be fixed by bonding and then coupled with the case body 10.

Further, although the shock-absorbing block 46 may be made of a flexible or elastic material, e.g., rubber, an adhesive, rather than the rubber, may function as a shock-absorbing block. In an implementation, a double shock-absorbing block may be implemented by applying an adhesive on the flexible material.

If an external shock is applied to a lower portion of the case body 10, the load may be primarily attenuated by the shock-absorbing cap 30 and then secondarily attenuated by the shock-absorbing block 46, before being transmitted to the case body 10.

Accordingly, the load transmitted through the shock-absorbing cap 30 may be exerted in the case body 10, with a magnitude thereof sufficiently reduced. Thus, damage to the case body 10 and the electrode assembly 50 therein may be correspondingly reduced.

Although not illustrated, it is also possible to achieve higher shock-absorbing efficiency than using a plurality of stacked shock-absorbing blocks 46.

For example, implementing the sub-shock absorber 40 including the shock-absorbing block 46 may not result in a change in design of the shock-absorbing cap 30. In particular, different from the previous embodiment, omitting formation of the shock-absorbing grooves 42 on the shock-absorbing cap 30 may simplify manufacturing.

In addition, the present embodiment may achieve a load distribution effect due to, e.g., shock-absorbing grooves, as in the previous embodiment, when the load is transmitted through the shock-absorbing block 46 that includes shock-absorbing grooves 42 on the shock-absorbing block 46. In this case, the shock-absorbing grooves 42 may be formed through the shock-absorbing block 46.

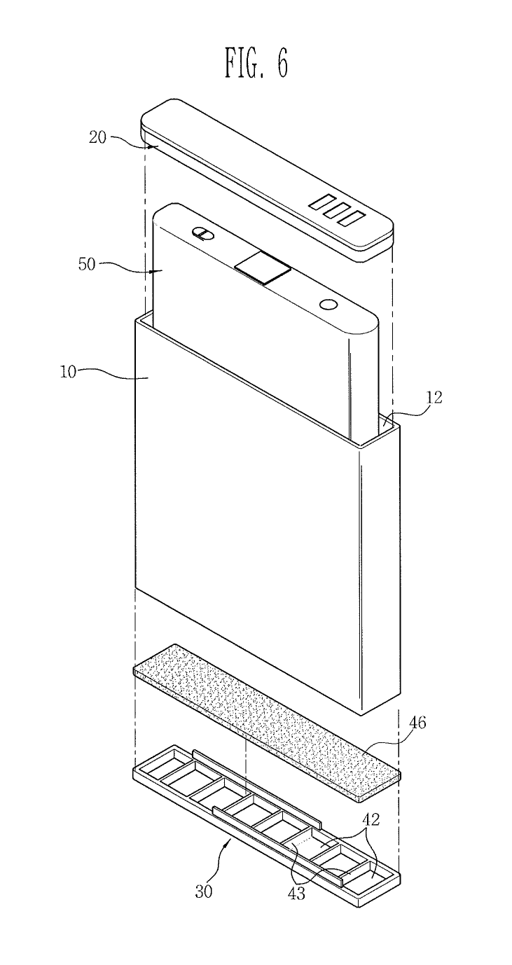

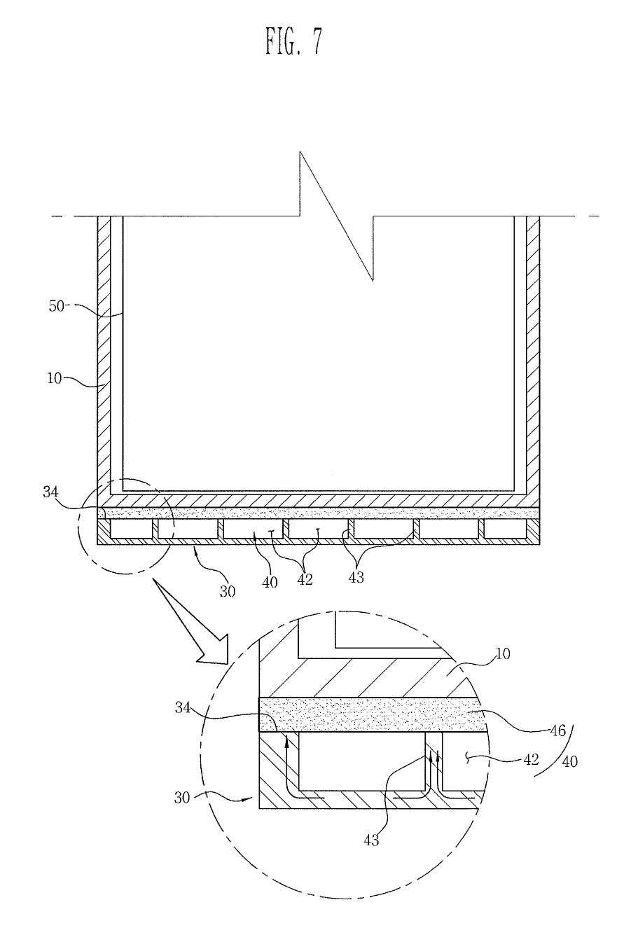

FIG. 6 illustrates an exploded perspective view of a case according to yet another embodiment. FIG. 7 illustrates a cross-sectional view of an assembled state of the case of FIG. 6. For example, FIGS. 6 and 7 illustrate views showing a case, which includes combined structures of the previous embodiments.

For example, the sub-shock absorber 40 of the present embodiment may include the shock-absorbing grooves 42 on the shock-absorbing cap 30 as well as the shock-absorbing block 46 stacked on the top of the shock-absorbing cap 30.

In this configuration, a shape and number of the shock-absorbing grooves 42 may be determined by modifications described with reference to the previous embodiments. In addition, a structure and material of the shock-absorbing block 46 may be the same as in the previous embodiment.

With the sub-shock absorber 40 included in the structure, as shown in FIG. 7, load initially applied to the shock-absorbing cap 30 may be transferred and concentrated to the ribs 44 and the edge 34 by the shock-absorbing groove 42 prior to being transmitted to the shock-absorbing block 46. Then, the load may be attenuated again by the self-shock absorbing properties of the shock-absorbing block 46 before being transmitted to the case body 10. For example, arrows shown in the ribs 43 and edges 34 represent a path of the shock applied to the shock-absorbing cap 30 and transmitted to the shock-absorbing block 46.

For example, effects of shock-absorbing by the shock-absorbing grooves 42 and the shock-absorbing block 46 may be simultaneously achieved; and shock-absorbing efficiency may be increased.

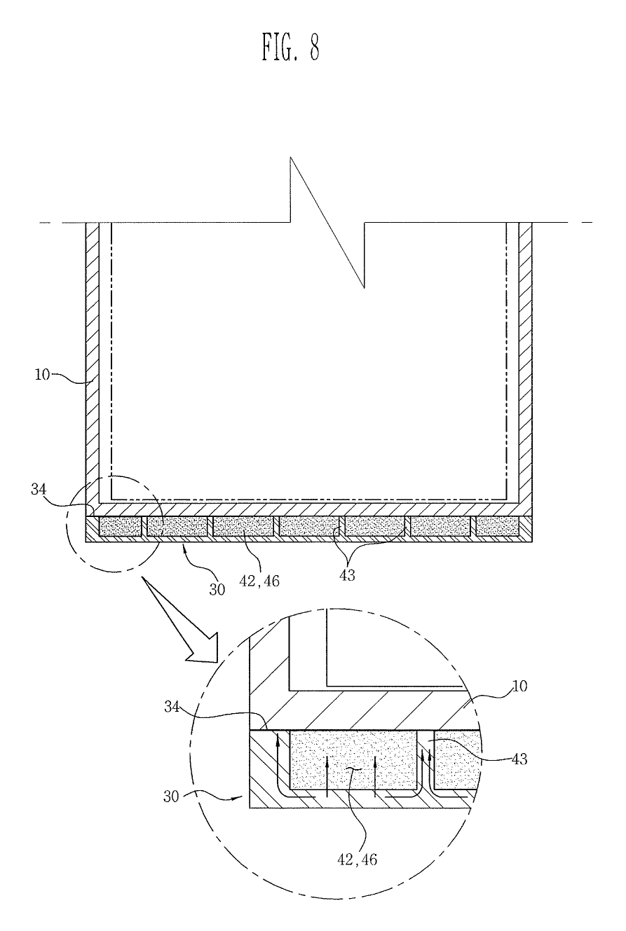

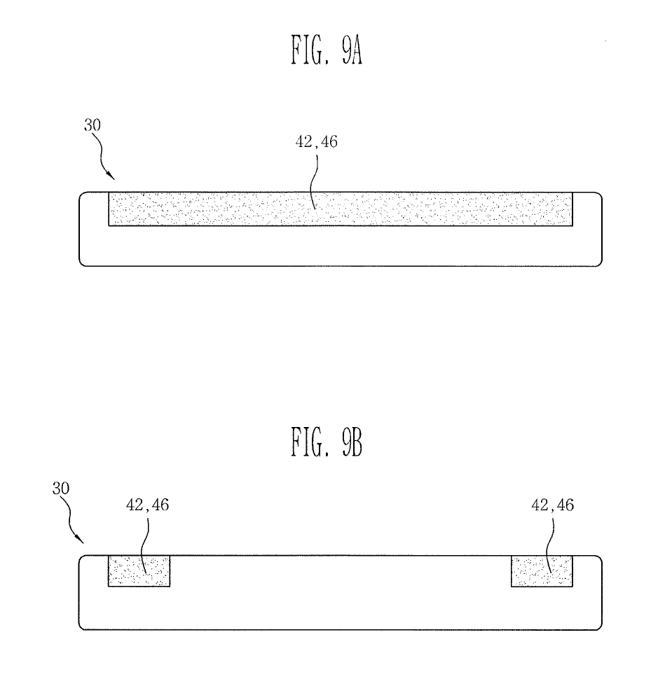

FIG. 8 illustrates a cross-sectional view of a case according to still another embodiment. FIGS. 9A and 9B illustrate enlarged cross-sectional views of modified examples of the shock-absorbing cap of FIG. 8. For example, FIGS. 8 and 9 illustrate views in which a basic configuration is the same as that of the previous embodiment using both the shock-absorbing grooves and the shock-absorbing block, but a mounting structure for the shock absorbing block is modified.

For example, shock-absorbing grooves 42 may be formed on the shock-absorbing cap 30; and shock-absorbing blocks 46 may fill in the shock-absorbing grooves 42.

According to this structure, shock initially applied to the shock-absorbing cap 30 may be transmitted to the shock-absorbing blocks 46 in the shock-absorbing grooves 42 while being distributed to the ribs 43 and the edge 34. Accordingly, a magnitude of the shock may be reduced by the self-shock absorbing properties of the shock-absorbing blocks 46.

For example, a load applied to the shock-absorbing cap 30 may be transferred to the ribs 43 and the edge 34 with the magnitude reduced by the shock-absorbing blocks 46. Then, the load may be transmitted to the case body 10 such that substantially the same shock-absorbing effect as the previous embodiment may be achieved. For example, arrows shown in the ribs 43, edges 34, and shock-absorbing grooves 42/shock-absorbing blocks 46 represent a path of the shock applied to the shock-absorbing cap 30 and transmitted to the case body 10.

As described above, since the shock-absorber 40 has may have a structure including the shock-absorbing blocks 46 filled in the shock-absorbing grooves 42, it is possible to prevent a size of the secondary battery from being increased by a thickness of the shock-absorbing blocks 46 on the shock-absorbing cap 30, as in the previous embodiment.

FIG. 9A illustrates one shock-absorbing groove 42 formed on the shock-absorbing cap 30 and the elastic shock-absorbing block 46 being seated in the shock-absorbing groove 42. FIG. 9B illustrates shock-absorbing grooves 42 formed at both side ends of the shock-absorbing cap 30 and shock-absorbing blocks 46, which may include, e.g., rubber, adhesives, or elastic members, in the shock-absorbing grooves 42.

The embodiments may provide advantages over a structure in which a specific shock-absorbing member is provided, but a plate member is simply attached to the bottom of the case body by a label tape. For example, according to the embodiments, when the secondary battery, e.g., falls, shock applied to the bottom of the case body may be locally transmitted around edges of the bottom, thus avoiding adverse effects on the electrode assembly. In particular, shock applied to the bottom of the case may be dissipated not throughout the entire case but rather localized to edges and/or ribs. Thus, serious damage to the secondary battery itself may be prevented even when the shock is repeated.

The embodiments provide a case for a secondary battery capable of preventing damage to a case body and an electrode assembly therein by including a sub-shock absorber in a shock-absorbing cap to improve shock-absorbing efficiency, when external shock is applied.

The embodiments provide a case for a secondary battery capable of preventing damage to the case body and the electrode assembly therein and improving safety of the secondary battery by transferring shock applied to the shock-absorbing cap to ends thereof, rather than throughout the shock-absorbing cap, so that any damage to the case may be relegated to ends thereof.

The embodiments may improve shock-absorbing efficiency when external shock is applied by including a sub-shock absorber in a shock-absorbing cap.

For example, a contact area between the shock-absorbing cap and the case body may be reduced by forming the sub-shock absorber in a groove on the shock-absorbing cap. Thus, load applied to the case body may be more attenuated by dispersing the shock throughout the shock-absorbing cap.

Further, it is possible to reduce shock transmission to the case body by implementing the sub-shock absorber in a flexible plate.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A case for a secondary battery, the case comprising:
a case body, the case body having bottom and a space for receiving an electrode assembly; and
a shock-absorbing cap, the shock-absorbing cap having a bottom and an edge extending from the bottom of the shock-absorbing cap, the edge being coupled to the bottom of the case body,
wherein the shock-absorbing cap includes a sub-shock absorber, the sub-shock absorber being configured to distribute and transmit shock applied to the bottom of the shock-absorbing cap.

2. The case for a secondary battery as claimed in claim 1, wherein the sub-shock absorber includes one or more shock-absorbing grooves on the shock-absorbing cap, the shock-absorbing grooves having a predetermined depth.

3. The case for a secondary battery as claimed in claim 2, wherein the sub-shock absorber includes a plurality of the shock-absorbing grooves at regular intervals.

4. The case for a secondary battery as claimed in claim 3, wherein each of the plurality of shock-absorbing grooves has the same area.

5. The case for a secondary battery as claimed in claim 2, wherein the sub-shock absorber includes a plurality of the shock-absorbing grooves, the shock-absorbing grooves being symmetrically disposed at sides of a center of the shock-absorbing cap.

6. The case for a secondary battery as claimed in claim 2, wherein the sub-shock absorber includes a plurality of the shock-absorbing grooves, the shock-absorbing grooves being disposed at opposite side ends of the shock-absorbing cap.

7. The case for a secondary battery as claimed in claim 2, wherein:
the shock-absorbing cap further includes connection ribs between the shock-absorbing grooves, and
the connection ribs and the edges of shock-absorbing cap contact the bottom of the case body.

8. The case for a secondary battery as claimed in claim 2, wherein the shock-absorbing cap is made of polycarbonate.

9. The case for a secondary battery as claimed in claim 2, further comprising shock-absorbing blocks in the shock-absorbing grooves.

10. The case for a secondary battery as claimed in claim 9, wherein the shock-absorbing blocks include an elastic body, the elastic body having an elasticity greater than an elasticity of the shock-absorbing case.

11. The case for a secondary battery as claimed in claim 10, wherein the elastic body includes any one of rubber and an adhesive.

12. The case for a secondary battery as claimed in claim 2, wherein:
the shock-absorbing cap has a thickness, and
the predetermined depth is about 50% or less of the thickness of the shock-absorbing cap.

13. The case for a secondary battery as claimed in claim 12, wherein the predetermined depth is about 0.1 mm to about 0.25 mm.

14. The case for a secondary battery as claimed in claim 1, wherein the shock-absorbing cap further includes one or more connecting protrusions on the edge of the shock-absorbing cap, the connecting protrusions extending along and covering a side of the bottom of the case body.

15. The case for a secondary battery as claimed in claim 14, wherein the connection protrusions are on a long side of the edge of the shock-absorbing cap.

16. A case for a secondary battery, the case comprising:
a case body, the case body having a bottom and a space for receiving and electrode assembly;
a shock-absorbing cap, the shock-absorbing cap including:
a bottom,
an edge extending from a side of the bottom of the shock-absorbing cap, the edge being coupled to the bottom of the case body,
one or more connecting protrusions extending from long sides of the edge; and
a specific shock-absorbing block on top of the shock-absorbing cap.

17. The case for a secondary battery as claimed in claim 16, wherein the shock-absorbing cap is made of any one of polycarbonate and polypropylene.

18. The case for a secondary battery as claimed in claim 16, wherein the shock-absorbing block is stacked on top of the shock-absorbing cap.

19. The case for a secondary battery as claimed in claim 18, wherein the shock-absorbing block is made of a material having an elasticity greater than an elasticity of the shock-absorbing cap.

20. The case for a secondary battery as claimed in claim 19, wherein the shock-absorbing block includes any one of rubber and an adhesive.

21. A secondary battery, comprising:
a case for a secondary battery as claimed in claim 1;
an electrode assembly in the case; and
a cap assembly connected with the electrode assembly and coupled to an upper end of a case body.
